(19) United States
(12) Patent Application Publication
(10) Pub. No.: US 2026/0071743 A9
(43) Pub. Date: Mar. 12, 2026

(54) WIRELESS COMMUNICATION SYSTEM FOR CONTROLLING LIGHTING DEVICES

(71) Applicant: Richard d. Ashoff, Newport Beach, CA (US)

(72) Inventor: Richard d. Ashoff, Newport Beach, CA (US)

(21) Appl. No.: 19/071,717

(22) Filed: Mar. 5, 2025

Related U.S. Application Data
(60) Provisional application No. 63/561,676, filed on Mar. 5, 2024.

(51) Int. Cl. F21V 23/00; F21S 4/26; F21V 23/04; F21Y 103/10; F21Y 113/13; F21Y 115/10; H05B 47/115; H05B 47/12; H05B 47/19

(52) U.S. Cl. CPC F21V 23/009; F21S 4/26; F21V 23/0471; H05B 47/115; H05B 47/12; H05B 47/19; F21Y 2103/10; F21Y 2113/13; F21Y 2115/10

(57) ABSTRACT

The current subject matter relates to a lighting device having an LED strip having a plurality of light emitting diodes, a tubular enclosure configured to sustain the LED strip, a control board having a processor, speaker, sensor, microphone, a modem, and an antenna, the processor being communicatively coupled to the LED strip having the plurality of light emitting diodes, and the processor being configured to control the light emitting diodes, the control board configured to connect to at least one of a cellular network or WiFi via the modem and the antenna, a power board coupled to the LED strip having the plurality of light emitting diodes, and two opposing end caps situated at both ends of the tubular enclosure configured to receive power, the two opposing end caps configured to receive power for supplying power to the power board and the control board.

### CROSS-REFERENCE TO RELATED APPLICATIONS

This application claims priority to U.S. Provisional Application No. 63/561,676 entitled “LIGHTING DEVICE MESH NETWORK” and filed on Mar. 5, 2024, the disclosure of which is incorporated herein by reference in its entirety.

### TECHNICAL FIELD

The subject matter described herein relates to lighting devices, and in particular, the lighting devices interconnected in a mesh network.

### BACKGROUND

A standard fluorescent overhead lighting assembly typically consists of a ceiling fixture that contains an electronic ballast. Above the fluorescent tube lamps, metal concave reflectors are positioned to direct emitted light downward toward the floor. The ballast converts AC line voltage to the DC power required by the fluorescent tubes and lowers the power supply to a voltage level suitable for their operation. A starter circuit provides the necessary voltage pulse to initiate current flow through the ionized gas within the tube.

Conventional fluorescent lighting fixtures include mounting brackets that secure light sockets, which hold and electrically connect the tubular fluorescent lamps. The fluorescent tube lamps typically have a bi-pin or two-pin connector on their tubular body, providing both mechanical support and an electrical connection to the power supply through the fixture's lamp holders. To install the lamp, the bi-pins are inserted into slots in the lamp holders and then rotated to lock them securely in place.

The most sizes of fluorescent lights are ¼ inch diameter (T2), ⅝ inch diameter (T5) and 1 inch diameter (T8) and with length ranging from about 6 inches to 8 feet. The 4 foot long, 1 inch diameter (T8) fluorescent lamp is one of the most widely deployed lamps worldwide in commercial and industrial settings.

Some legal codes by legal institutions, such as in the United States, necessitate that some structures, such as parking lots and staircases, are required to have lights on twenty-four hours a day, three hundred and sixty-five days a year. This is typically provided using conventional lighting devices, such as electric bulbs and fluorescent lights. Keeping these lighting devices permanently in an on state uses a significant amount of energy. According to Energy Information Administration, lighting uses, on average, accounts for 25% of all the energy produced and used annually in the United States of America. Therefore, it can be advantageous to provide lighting devices that optimally utilize energy as the need arises, while still complying with the legal lighting requirements needed to provide proper illumination.

As energy costs continue to rise, commercial building owners and operators look for new, innovative ways to save energy and reduce operating costs. Existing buildings previously required a rework or complete replacement of light fixtures to save money. While the new fixtures seem relatively low-cost, associated labor and disposal costs quickly push the ROI far beyond feasibility.

### SUMMARY

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented hereinbelow. It is to be understood that both the following general description and the following detailed description are exemplary and explanatory only and are not restrictive.

In accordance with the embodiments disclosed herein, the present disclosure is directed to an apparatus having an LED strip having a plurality of light emitting diodes, a tubular enclosure configured to sustain the LED strip, a control board having a processor, a modem, and an antenna, the processor being communicatively coupled to the LED strip having the plurality of light emitting diodes, and the processor being configured to control the light emitting diodes, the control board configured to connect to at least one of a cellular network or WiFi via the modem and the antenna, a power board coupled to the LED strip having the plurality of light emitting diodes, and two opposing end caps situated at both ends of the tubular enclosure configured to receive power, the two opposing end caps configured to receive power for supplying power to the power board and the control board.

In some variations, the modem and the antenna receives information from the at least one of the cellular network or WiFi network, the information including a color to be generated by the plurality of light emitting diodes. Additionally, the power board is enclosed in a first end cap at a first end of the tubular enclosure, and wherein the control board is enclosed in a second end cap at a second end of the tubular enclosure, the first end opposing the second end. Further, the two opposing end caps have a set of pins configured to receive power from an electrical ballast via a tube socket.

In some variations, the tube socket is configured to receive at least one of a T5, T8, or T12 fluorescent light. Additionally, the power board includes a transformer configured to convert power from a 120-volt alternating current source. Further, the power board may include a transformer configured convert power from a ballast.

In some variations, the modem is a WiFi-LiFi network and the cellular network. Additionally, the modem is a WiFi-LiFi network and the cellular network. Further, the control board includes a microphone and a speaker.

In another embodiment, the lighting device mesh network system of the present disclosure provides a primary lighting device including: a first LED strip having a first plurality of LEDs; a first tubular enclosure configured to sustain the first LED strip; a first control board having a first processor, a first modem, and a first antenna, the first processor being communicatively coupled to the first LED strip having the first plurality of LEDs, and the first processor being configured to control the first plurality of LEDs, the first control board configured to connect to at least one of a cellular network or a WiFi network via the first modem and the first antenna; a first power board coupled to the first LED strip having the first plurality of LEDs; and two opposing end caps situated at both ends of the first tubular enclosure configured to receive power, the two opposing end caps configured to receive power for supplying power to the first power board and the first control board.

The lighting device mesh network system may further provide a central portal configured to wirelessly connect to the primary lighting device via at least one of the cellular network or the WiFi network, the primary lighting device being configured to receive instructions through the central portal via the at least of the cellular network or the WiFi network.

The lighting device mesh network system may further provide a secondary lighting fixture including: a second LED strip having a second plurality of LEDs; a second tubular enclosure configured to sustain the second LED strip; a second control board having a second processor, a second modem, and a second antenna, the second processor being communicatively coupled to the second LED strip having the second plurality of LEDs, and the second processor being configured to control the second plurality of LEDs, the second control board configured to connect to the primary lighting device via the second modem and the second antenna; a second power board coupled to the second LED strip having the second plurality of LEDs; and two opposing end caps situated at both ends of the second tubular enclosure, the two opposing end caps configured to receive power for supplying power to the second power board and the second control board,

In the lighting device mesh network system, the secondary lighting device may be configured to communicate with the primary lighting device via the second modem and the second antenna, and wherein the primary lighting device is configured to activate the second plurality of LEDs based on a command received by the second modem from the primary lighting device.

In some variations, the central portal is configured to generate a visual mapping of a physical layout of the primary lighting device and the secondary lighting device. Further, the first modem and the second modem have separate IP addresses. Additionally, the first modem and the second modem include at least a Bluetooth protocol. Further, the first modem and the second modem are compatible with a WiFi-LiFi network and the cellular network. Additionally, the central portal includes a gateway to a user device, wherein the command is received from the user device.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure. As it will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### DESCRIPTION OF DRAWINGS

FIG. 1A illustrates an exploded view of an implementation of a linear light emitting device having a tubular enclosure and a control module;

FIG. 1B illustrates an assembled view of an implementation of a linear light emitting device having a tubular enclosure and a control module;

FIG. 1C illustrates an assembled view of an implementation of a linear light emitting device having an LED strip inside a tubular enclosure and a control module;

FIG. 2 illustrates an LED strip having power pins and control pins;

FIG. 3A illustrates an example of the tubular enclosure having slots at both ends;

FIG. 3B illustrates another example of the tubular enclosure;

FIG. 4 illustrates an example of the LED strip situated inside of the tubular enclosure;

FIG. 5A illustrates an example configuration of a control board having an antenna and a processor, where the processor is configured to control the LEDs at the LED strip;

FIG. 5B illustrates an example of a carrier board configured to couple the control board to the light emitting device;

FIG. 5C illustrates an example configuration of the control board coupled to the LED strip situated inside of the tubular enclosure;

FIG. 6A illustrates an example of a power board configured to power the LEDs at the LED strip;

FIG. 6B illustrates an example configuration of the power board coupled to the LED strip situated inside of the tubular enclosure;

FIG. 7 illustrates an example of an end cap configured to encapsulate at least one of the control board, the carrier board, or the power board, or any combination thereof;

FIG. 8 illustrates an example of pins configured to suspend the end cap;

FIG. 9 illustrates a cross-sectional view of an example of an end cap configured to encapsulate at least one of the control board, the carrier board, or the power board, or any combination thereof;

FIG. 10 illustrates a perspective view of an example of an end cap configured to encapsulate the control board, the carrier board, and the power board;

FIG. 11A illustrates yet another view of an example of an end cap having a sensor module;

FIG. 11B illustrates yet another view of an example of an end cap having internal slots; and

FIG. 12 illustrates an example of a block diagram representing a lighting device mesh network including a primary lighting device and a secondary lighting device in a hierarchical network having a central portal and a communication device.

Like reference symbols in the various drawings indicate like elements.

### DETAILED DESCRIPTION

The subject matter emerges as a groundbreaking IoT-enabled lighting solution, revolutionizing not just the realm of lighting but the connectivity between devices. It introduces a sophisticated system that intertwines lighting fixtures with IoT sensors, enabling a wide array of functionalities beyond illumination. By seamlessly integrating IoT technology into interior lighting fixtures, The subject matter positions itself as a pivotal player in energy conservation, smart building management, and the facilitation of the Industrial Internet of Things (IIoT).

The subject matter represents an innovative lamp replacement solution that seamlessly integrates into existing fixtures, revolutionizing traditional lighting systems. This groundbreaking technology offers a simple yet powerful upgrade, eliminating the need for fixture rewiring or replacements. By replacing the existing fluorescent lamp or LED lighting source, building structures can instantly benefit from its advanced LED technology.

The subject matter can include communication components that facilitate communication between the primary lighting devices and the secondary lighting devices. The primary lighting devices can have an address identifying location, host, and/or location interface, such as an internet protocol (IP) address. This internet protocol address can allow an isolation/separation of this one lighting device from other, for example, thirty-five (36−1=35) lighting devices. Here, the other thirty-five lighting devices can act as a secondary to the one primary lighting device, wherein the secondary lighting devices can receive commands from the primary for activation, inactivation, dimming, brightening, changing color, and/or the like. These thirty-five secondary lighting devices can receive wireless communication commands from the one primary lighting device, thereby establishing a zone lighting environment without any modifications to already existing fixtures.

The subject matter can be reprogramed over the air, keeping pace with advancing technology, without having to upgrade the infrastructure; simply by changing the existing fluorescent lamp or LED lamp.

Simply by changing a light bulb, a commercial building can reduce their lighting costs by 61%, communicate with other smart devices, and optimally utilize energy as the need arises, all while complying with the legal lighting requirements needed to provide proper illumination.

The IoT integration offers not only lighting control but also the ability to gather non-lighting metrics like building performance and human activity, the subject matter communicates with other smart devices, providing insights into the environment. The lighting device mesh network integrates lighting fixtures with IoT technology for advanced functionality. The lighting device mesh network enhances energy efficiency, smart building management, and IIoT integration. The lighting device mesh network offers internet access, LiFi technology, wireless interoperability, but also integrates lighting with building controls.

The subject matter described offers an effective energy savings strategy for buildings with existing light fixtures. Simply switching the existing lamp, in the existing fixture, offers not only energy savings, internet access, LiFi technology, wireless interoperability, but also integrates lighting with building controls.

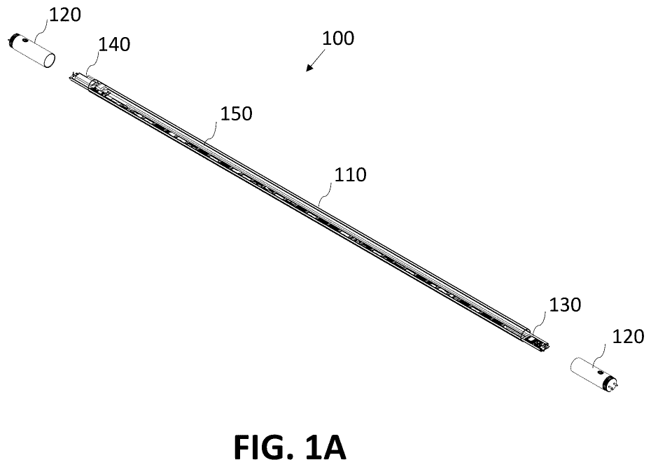

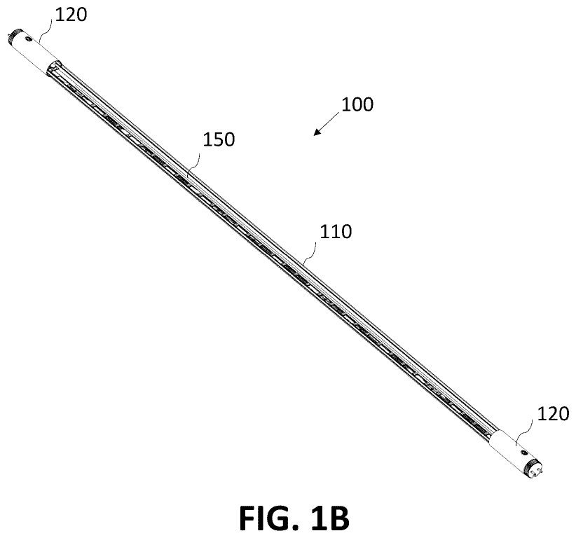

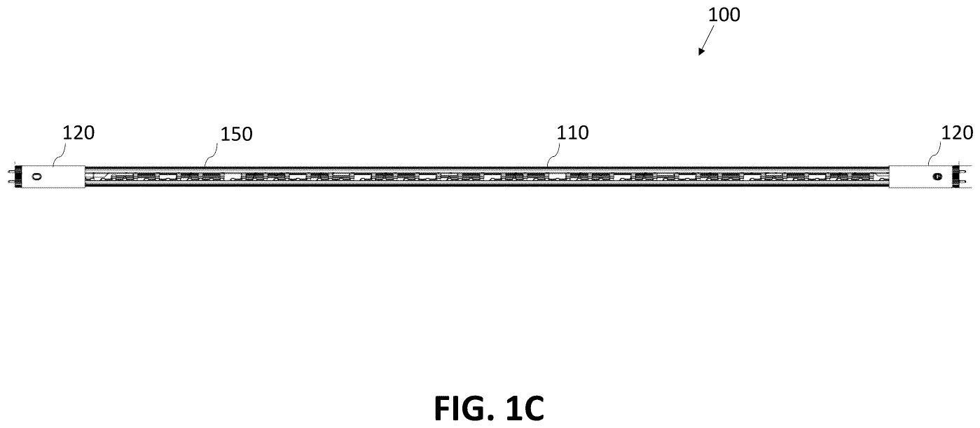

FIG. 1A illustrates an exploded view of an implementation of an interconnected light emitting device 100 having a tubular enclosure 110 and a control module. The interconnected light emitting device 100 includes a tubular enclosure 110, two opposing end caps 120, a control board 130, a power board 140, and an LED strip 150 including a plurality of LEDs 210. The LED strip 150 is configured to fit inside the tubular enclosure 110. The LED strip 150 extends the length of the tubular enclosure 110 and includes LEDs linearly arranged in a pattern along the length of the LED strip 150. In some embodiments, the LED strip 150 may extend beyond the length of the LED strip 150.

The power board 140 is configured to connect to one end of the LED strip 150 and the control board 130 is configured to connect to an opposing end of the LED strip 150. The two opposing end caps 120 couple to the ends of the tubular enclosure 110. In the coupled state, the two opposing end caps may enclose the power board 140 and the control board 130 at the opposing ends of the tubular enclosure 110. The end cap 120 may be the same diameter as the tubular enclosure 110. The end cap 120 may be larger than the diameter of the tubular enclosure 110 and may partially overlap with the ends of the tubular enclosure 110. The end cap 120 may be flush with the end of the tubular enclosure 110 in a coupled state.

FIG. 1B illustrates an assembled view of an implementation of an interconnected light emitting device 100 having a tubular enclosure 110 and a control module. The tubular enclosure 110 may include the LED strip 150. The control board 130 may have a processor, a modem, and an antenna 510. The processor may be communicatively coupled to the LED strip 150 having the plurality of light emitting diodes. The processor may be configured to control the light emitting diodes. The control board 130 may be configured to connect to at least one of a cellular network or WiFi via the modem and the antenna 510. The power board 140 may be coupled to the LED strip 150 having the plurality of light emitting diodes. The two opposing end caps may be situated at both ends of the tubular enclosure 110 configured to receive power. The two opposing end caps may be configured to receive power for supplying power to the power board 140 and the control board 130.

FIG. 1C illustrates an assembled view of an implementation of an interconnected light emitting device 100 having an LED strip 150 inside a tubular enclosure 110 and a control module. The modem and the antenna 510 at the control module may receive information from the at least one of the cellular network or WiFi network, the information including a color to be generated by the plurality of light emitting diodes. The power board 140 may be enclosed in a first end cap 120 at a first end of the tubular enclosure 110, and wherein the control board 130 is enclosed in a second end cap 120 at a second end of the tubular enclosure 110, the first end opposing the second end. The two opposing end caps may have a set of pins configured to receive power from an electrical ballast via a tube socket. The tube socket is configured to receive at least one of a T5, T8, or T12 fluorescent light. The power board 140 includes a transformer configured to convert power from a 120-volt alternating current source. Additionally, and/or alternatively, the power board 140 further includes a transformer configured convert power from a ballast.

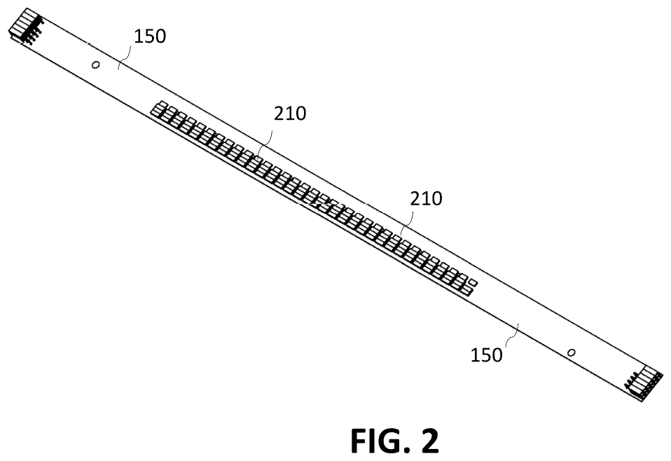

FIG. 2 illustrates an implementation of an LED strip 150 having a plurality of LEDs 210. The LED strip 150 extends the length of the tubular enclosure 110 and includes LEDs linearly arranged in a pattern along the length of the LED strip 150. The LED strip 150 includes white and color LEDs based on product SKU. In a full color version of the LED strip 150, full color lighting is achieved with a combination of red, green, blue, and white lights. In a white-only version of the LED strip 150 white lighting is achieved using white LEDs.

The LEDs noted herein can be white LEDs that can be phosphor-based in any correlated color temperature (CCT) and color rendering index (CRI). In some implementations, LEDs either can be of any color (for example, red, green, blue, orange, yellow, or any other color) or can be white-light LEDs that can be formed by combining red, green and blue colors. The LEDs can use quantum dots to efficiently transform the color of light from one frequency to another. Some LEDs can transmit light associated with ultraviolet (UV) or infrared (IR) frequencies. The LEDs can include organic light emitting diodes (OLEDs). The LEDs can be activated by providing either direct current (DC) or alternating current (AC). The alternating current LEDs can be used in conjunction with power transformers.

The LED strip 150 can further include end terminals. The end terminals can be male terminals that can combine with female terminals of a lighting container/fixture. Further, the lighting device can include electrical wires.

In some implementations, the LED strip 150 may be other lighting devices. In some implementations, the LED strip 150 may include other devices, such as heating controls, cooling controls, heating ventilation and air conditioning (HVAC) systems, photosensitive windows, electro-sensitive windows, alarms, coffee maker, toaster, and/or any other electrical/electronic device.

In some implementations, the LED strip 150 can have lengths between one foot and twelve feet and can have a lifetime of 30 years or more. The LED strip 150 may include an ultra-violet LED for disinfecting the room and other surfaces in contact with the light from the ultra-violet LED.

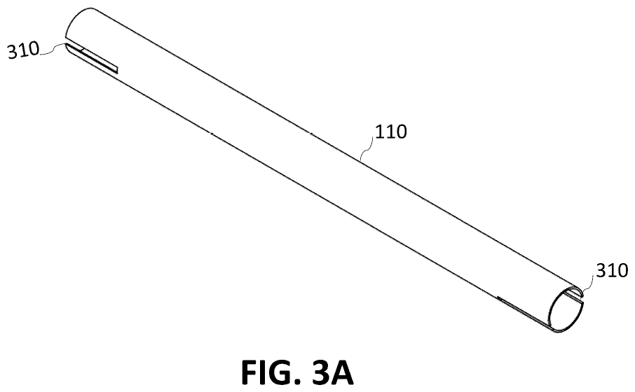

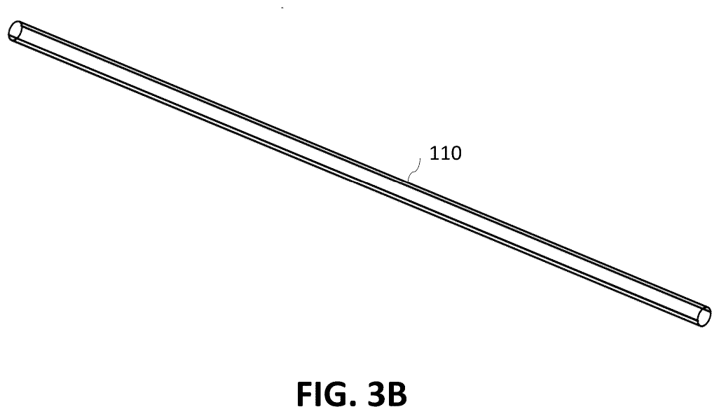

FIG. 3A illustrates an implementation of a tubular enclosure 110 configured to enclose the LED strip 150. The tubular enclosure 110 may be translucent or partially translucent. The tubular enclosure 110 may have a cylindrical shape. The tubular enclosure 110 may have slots 310 or apertures 710 for securing the power board 140 or the control board 130. The slots 310 or apertures 710 may be at the opposing ends of the tubular enclosure 110.

In some implementations, the tubular enclosure 110 matches the dimensions of a T5, T8, or T12 fluorescent light bulb. In some implementations, the tubular enclosure 110 is configured to encapsulate the control board 130 and the power board 140. In some implementations, the tubular enclosure 110 can incorporate a single lighting device. Variations are possible, where multiple lighting devices can be incorporated in one tubular enclosure 110, wherein those multiple lighting devices can be connected in a series electrical configuration and/or in a parallel electrical configuration. The tubular enclosure 110 may have a different shape, including a prism, parallelogram, a box, an oval, or the like.

FIG. 3B illustrates another example of the tubular enclosure 110.

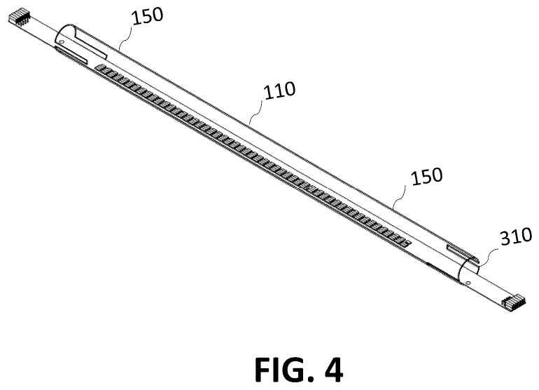

FIG. 4 illustrates an example of the LED strip 150 situated inside of the tubular enclosure 110. In some embodiments, the interconnected light emitting device 100 can be a single packaged structure that cannot be separated (that is, separated apart) into separate structures.

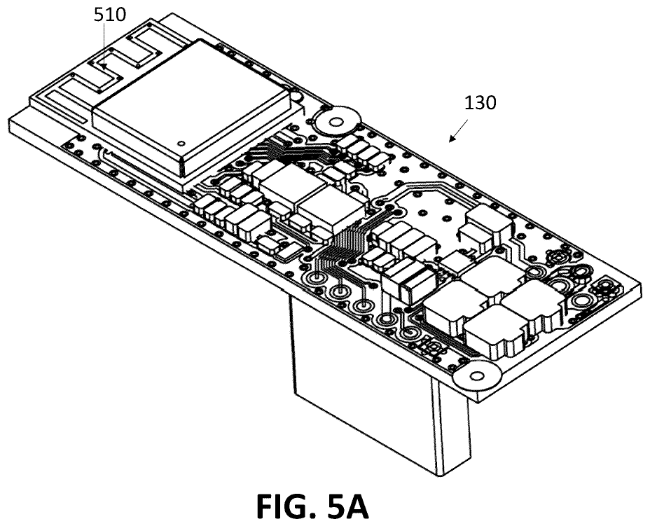

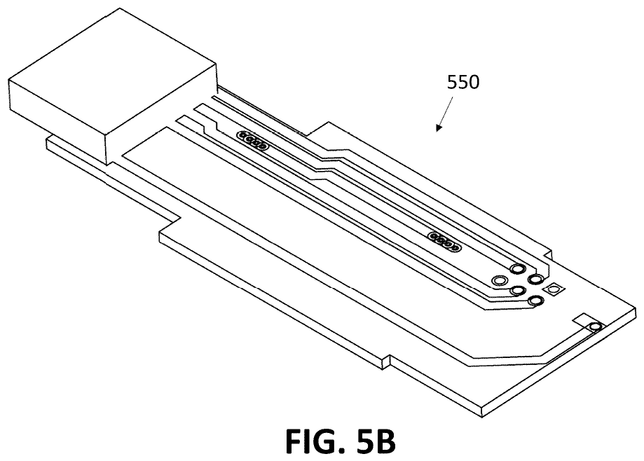

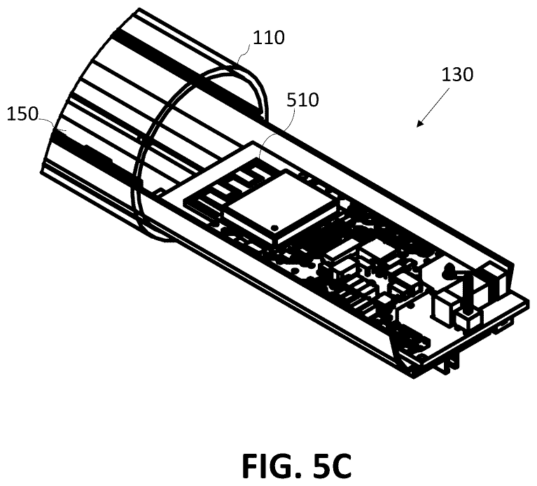

FIG. 5A illustrates an example configuration of a control board 130 having an antenna 510, a modem, and a processor, where the processor is configured to control the LEDs at the LED strip 150. The processor may instruct the LEDs to change colors. The processor may cause the LEDs to flash in a pattern.

The control board 130 may include a modem. The modem may be configured to connect to a cellular network and/or a WiFi network for controlling and operating the LEDs. The modem may have different functionalities depending on whether the modem is configured in a primary light fixture, a communication device, or a secondary light fixture. In a primary light fixture, the modem may connect to the internet using WiFi or a cellular network. In a secondary light fixture, the modem may connect and receive commands from the primary light fixture, communication device via Bluetooth, laser, or other mesh network systems.

The functionalities of the processors may vary depending on whether the processor is in a primary light fixture, communication device, or a secondary light fixture. In a primary light fixture or a communication device, the processor may direct commands and instructions to secondary light fixtures. The primary light fixtures and the secondary light fixtures are arranged in a hierarchy. Every secondary light fixture can connect to a communication device, a primary light fixture and cannot connect to a secondary light fixture. Every processor in a primary light fixture or a communication device may be configured to connect to a cellular/WiFi network. Every processor in a primary light fixture or a communication device may be connected to a secondary light fixture but can be connected to another communication device. Communication between the processors of the primary light fixtures must travel through the cellular/WiFi network. Communication between the processors of the primary light fixtures, communication device, and the secondary light fixtures can travel using a Bluetooth or other mesh network protocol.

When a primary-secondary configuration is formed in the network, the processor in the primary lighting fixture or communication device controls or sends instructions to processors of secondary lighting fixtures or communication devices. For example, when the processor of the primary lighting fixture or communication device sends a signal to a secondary lighting fixture or the communication device, the secondary lighting fixture or communication device may change color in response to a command forwarded by the processor the primary lighting fixture or communication device. In another example, the secondary lighting fixture may another device such as the photosensitive window. In such a case, the processor of the primary lighting fixture or communication device sends an instruction to the photosensitive window to open or close the photosensitive window. Other examples of action can be either activation or deactivation of one or more heating ventilation and air conditioning (HVAC) systems, electro-sensitive windows, and alarms.

As noted herein, the processor of the control board 130 may communicate with a central portal (for example, the web portal). The central portal can be used to control the network of the subject matter by administrative/service/staff personnel. The central portal can be implemented on a terminal device used by a user, such as a desktop computer, a laptop, a tablet computer (for example, IPAD), a mobile phone (that is, smart phone), and any other such device. The web portal and related devices can be used to perform various algorithms to perform operations noted herein, including scheduling, daylight harvesting or daylighting, task tuning to optimize the level and the area of lighting, demand response (e.g., reducing peak energy demand at key times), and manual controlling of the network.

The central portal may be configured to generate a visual mapping of the layout of all of the primary lighting fixtures and the secondary lighting fixtures. The central portal may allow the visual mapping to be interactive to allow commands to be sent to the primary lighting fixtures, or communication device and secondary lighting fixtures. The primary and secondary lighting fixture configuration reduces setup time and requires fewer devices to be actively connected to the internet.

In some embodiments, the control board 130 may have a microphone to receive voice commands to program information regarding its status, its IP address, its physical location. In some embodiments, the control board 130 may include a speaker to provide alerts to persons occupying the room, provide the status of the control board 130, provide the IP address or the control board 130, or provide the physical location of the control board 130. In some embodiments, the speaker of a primary lighting fixture may send an alert to a secondary lighting fixture in response to it or another secondary lighting fixture receiving a gunshot, sound at the microphone, or impulse at a sensor (e.g., concussion sensor). The communications between secondary lighting fixtures may travel through a corresponding primary lighting fixture to the cellular/Wifi network that transmits a signal to a different primary lighting fixture that is meshed with the other secondary lighting fixture.

FIG. 5B illustrates an example of a carrier board 550 configured to couple the control board 130 to the light emitting device. For example, the male terminals of the lighting device into corresponding female terminals within ends of the carrier board 550.

FIG. 5C illustrates an example configuration of the control board 130 coupled to the LED strip 150 situated inside of the tubular enclosure 110.

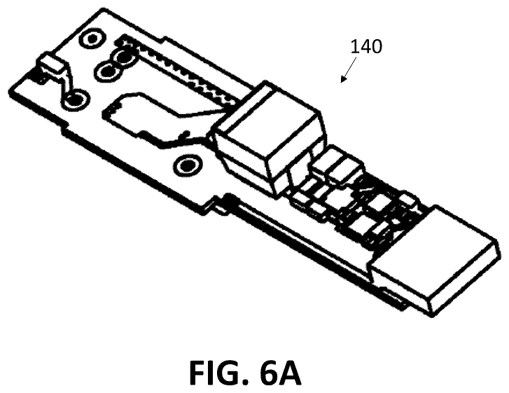

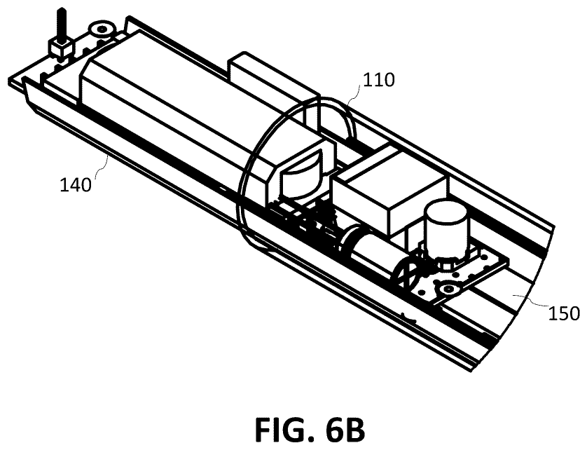

FIG. 6A illustrates an example of a power board 140 configured to power the LEDs at the LED strip 150. Additionally, the power board 140 may be configured to power the control board 130 and may be configured to adjust the power delivered to the LED strip 150 based on the instructions from the control board 130.

The power board 140 may be configured to convert incoming power to the power requirements of the LED strip 150. In one implementation, the power board 140 includes a transformer configured to convert power from a ballast. In another implementation, the power board 140 is configured to convert power from a 120, 240, or 270-volt alternating current source.

FIG. 6B illustrates an example configuration of the power board 140 coupled to the LED strip 150 situated inside of the tubular enclosure 110.

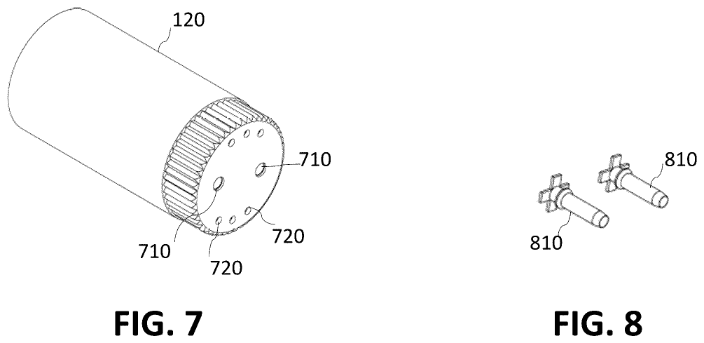

FIG. 7 illustrates an example of an end cap 120 configured to encapsulate at least one of the control board 130, the carrier board 550, or the power board 140, or any combination thereof. The end cap 120 may include grooves on the cylindrical surface for easy handling. The end cap 120 may include apertures 710 for inserting power pins or support pins 810. The end cap 120 may include viewing slits 720 for viewing status indicator of the control board 130 or the power board 140.

FIG. 8 illustrates an example of support pins 810 configured to suspend the end cap. The support pins 810 may allow the end cap 120 to be placed into a lighting fixture. This allows the lighting device to be placed in an existing light fixture without the need of any hardware. In one embodiment, the interconnected light emitting device 100 may replace a fluorescent bulb to upgrade to all the capabilities of the interconnected light emitting device 100. It can be as easy as changing a light bulb.

Thus, the interconnected light emitting device 100 can fit into standard/normal linear, Twin-Tube (2U, 4U), Quad-Tube, Plug-in (PL, GX, G24, etc.), Circular (Circline), U-Bend, Biaxial or Double-D fluorescent lamp fixtures. The total length of the interconnected light emitting device 100 can be substantially the same as legacy lamps, such as standard fluorescent lamps so that no modification may be necessary in order for the lighting device to fit into the apparatus (for example, the two opposite sockets of the apparatus) of an existing fixture. Thus, device may not need a modification to either the existing wiring or the existing fixture.

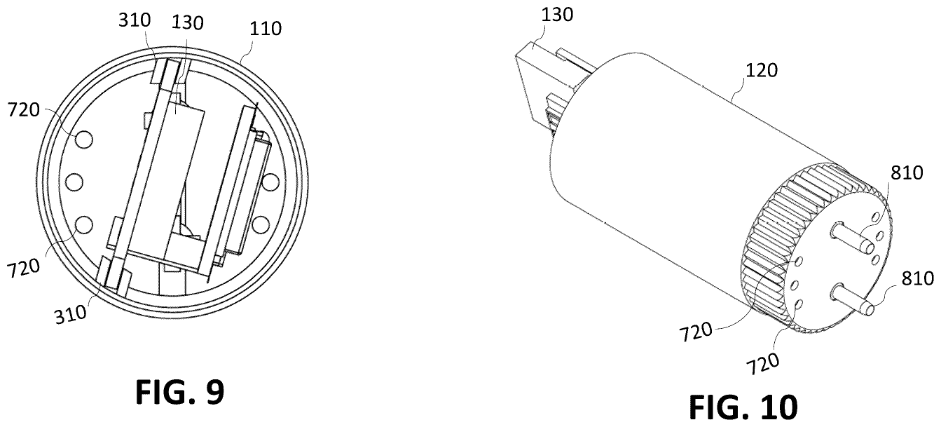

FIG. 9 illustrates a cross-sectional view of an example of an end cap 120 configured to encapsulate at least one of the control board 130, the carrier board 550, or the power board 140, or any combination thereof. The subject matter described can comprise of a carrier board 550, control board 130, end cap, power board 140, LED lighting source, LED board, LED ribbon, glass or plastic tube, microphone, sensor (e.g., concussion sensor), speaker and a transformer. These components may be contained in a glass or plastic tube as one unit.

In some embodiments, the wiring in the interconnected light emitting device 100 may function bi-directionally. This means that the power module and the control board 130 may be at either end of the tubular enclosure to install the interconnected light emitting device 100. In one embodiment, the power board 140 uses the input power that is electrically fed into opposite end caps of the interconnected light emitting device 100 and regulates down to a power supply that is used internally to power the control module and the LED strip. In this embodiment, an electrical connection from each of the end caps 120 is brought to the input side of the power board 140. This could be done with a wire that brings the electrical connection from one end cap 120 to the power module that is located in the other end cap 120. In some embodiments, a trace on the printed circuit board that runs the length of the light that holds the LEDs can bring the electrical connection to the power board 140.

FIG. 10 illustrates a perspective view of an example of an end cap 120 configured to encapsulate the control board 130, the carrier board 550, and the power board 140. The end cap 120 may have a fitting with the light fixture. This fitting can occur by inserting the end cap 120 into the tubular enclosure 110. The length of the lighting device can be same as or slightly smaller than the length of the lighting device container/fixture so that the lighting device can fit into an existing lighting device container/fixture (that is, a lighting device container/fixture already includes a conventional lighting device) without changing electric wiring associated with the lighting device container/fixture. The length between the ends can either be fixed or have a standard size (that is, standard according to industry standards, organizations, and/or other criteria—for example, 4 feet, 2 feet, 6 feet, or any other size), such as in existing containers/fixtures that can be already implemented in structures, such as parking lots, stairways, and the like. Thus, the lighting source can advantageously adjust in already existing containers/fixtures without changing any wiring associated with the already existing container/fixture.

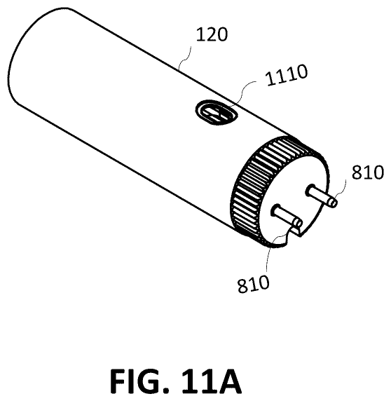

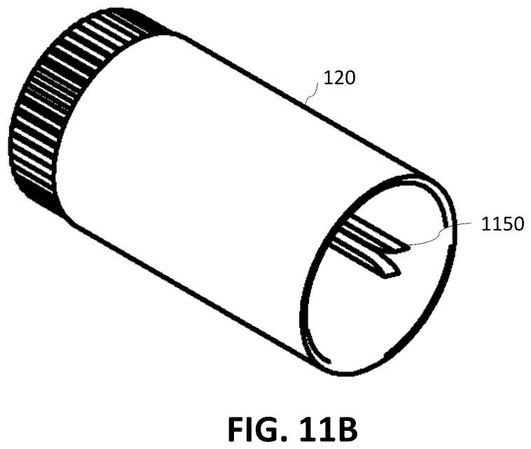

FIG. 11A illustrates yet another view of an example of an end cap 120 having a sensor module 1110. The sensor module 1110 may be configured to detect smoke, sound, motion, a laser pointer, carbon monoxide, heat, or the like.

In an example, the sensor module 1110 includes a smoke sensor configured to detect polluted air where the smoke sensor being communicatively coupled to the control board 130. The control board 130 may be configured to generate a different color at the plurality of light emitting diodes in response to the smoke sensor detecting polluted air satisfying a polluted air threshold.

In another example, the sensor module 1110 includes a sound sensor configured to detect loud noises where the sound sensor is communicatively coupled to the control board 130. The control board 130 may be configured to generate a different color at the plurality of light emitting diodes in response to the sound sensor detecting loud noises (e.g., gunshots) satisfying a decibel threshold.

In another example, school hallways can be lit with the interconnected light emitting device 100. The sensors can be programed to detect a gunshot. The control board 130 may be configured to generate a different color at the plurality of light emitting diodes in response to the gunshot, and then send a signal alerting secondary lighting fixtures or communication device, in response to primary lighting fixture receiving a gunshot signal. The different color lights can indicate a pathway such that the secondary lighting fixtures show a path away from the primary lighting fixture receiving the gunshot signal—for example the lights can flash, change color, or pulse to show a direction to travel that is away from the gunshot. Sounds through the speakers can also be used to inform students or users how to travel away from the gunshot, such as voice commands or instructions. In addition, the system can also cause doors to be locked or unlocked, allowing the gunman to be trapped and/or students to escape. Further, the communication device can call entities programed into the system that a gunshot was detected, such as police, fire, and other emergency personnel. In one embodiment, this notification can happen within 3 seconds of the primary lighting fixture receiving a gunshot signal.

In another example, hospitals have different audio codes to convey different emergencies. One of these can be “CODE BLUE”. If a “CODE BLUE” is announced, it would instruct a user to stop and listen. The control board 130 may be configured to generate a different color at the plurality of light emitting diodes in response to the announcement, and then send a signal alerting secondary lighting fixtures or communication device, in response to the primary lighting fixture receiving the announcement. The system can also cause the lighting fixtures to flash blue and direct the personnel to the room that is having the emergency. Further, the system can cause the communication devices to call entities programed into the system that there is an emergency. In one embodiment, such calls can occur within 3 seconds of the announcement.

In another example, if there is a fire in a building, the control board 130 may be configured to generate a different color at the plurality of light emitting diodes in response to the alarm. The system can then send a signal alerting secondary lighting fixtures or communication device, in response to primary lighting fixture receiving the announcement. For example, the system could cause the lighting fixtures to flash orange (or some other color) and direct the personnel out of the building. Orange is a color that is seen in smoke and thus a useful color to use in fire situation. The system can also cause the communication device to call entities programed into the system that there is a fire. In one embodiment such calls can occur within 3 seconds of the announcement.

In another example, the sensor module 1110 includes light sensor for detecting whether a laser pointer is pointed at the sensor module 1110. The control board 130 may be configured to generate status information (such as location information, IP address, physical location, hierarchy status) in response to the light sensor detecting light (e.g., laser light) satisfying a brightness threshold.

In some embodiments, the sensor module 1110 may be used to program information to the interconnected light emitting device 100. For example, the sensor module 1110 may include a light sensor to receive information related to its location, IP address, and network configurations. Identifying the light to assign a location can be done either with a laser pointer, a blinking pattern that the camera of the tablet or offsite system could decode, or having a light turn a particular color that the user can indicate where that light is located on the floorplan. After installation, the lights could also use WiFi-LiFi to configure their proximity to each other

FIG. 11B illustrates yet another view of an example of an end cap 120 having internal slots 1150. The end cap 120 having internal slots 1150 may be configured to suspend the control board 130, the carrier board 550, and the power board 140. The end cap 120 may be configured to work with other devices, such as automatically locking doors. The end cap 120 may be configured to couple to the ends of the tubular enclosure 110. In some embodiments, the end cap 120 may fuse to both ends of the tubular enclosure 110. While in one implementation, the lighting device can be a single packaged structure that cannot be separated (that is, separated apart) into separate structures; in some implementations, the lighting device can be separated apart into separate structures so as to more easily have at least one of the separated-apart structure replaced. For example, the fluorescent lighting source can be replaced with a newer fluorescent lighting source while the LEDs are maintained (that is, not replaced). The interconnected light emitting device 100 is configured to be inserted into a lamp sockets designed to sustain a fluorescent light bulb.

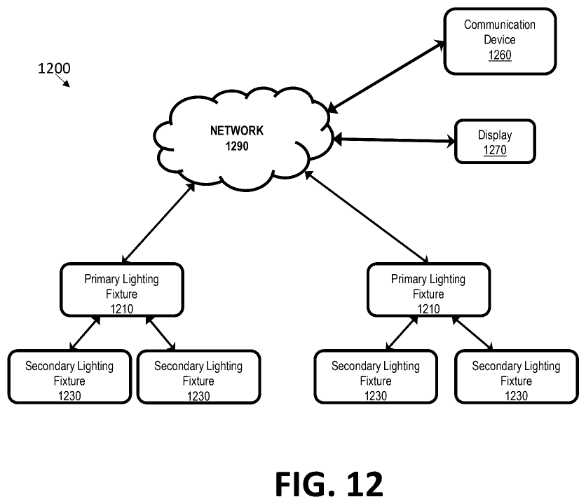

FIG. 12 illustrates a block diagram of a lighting device mesh network 1200 including a primary lighting fixture 1210, a secondary lighting fixture 1230, a display 1270, and a communication device 1260. The primary lighting fixture 1210 is communicatively coupled via a network 1290 and/or via a direct device-device connection. The network 1290 may be a wired and/or wireless network including, for example, a public land mobile network (PLMN), a local area network (LAN), a virtual local area network (VLAN), a wide area network (WAN), the Internet, a short-range radio connection, for example, Bluetooth, a peer-to-peer mesh network, and/or the like. The subject matter described herein can include a wireless networking arrangement that can include communication between lighting devices and other communication devices, as in accordance with some implementations of the current subject matter.

The network 1290 may include a central portal. The central portal may facilitate communication between communication devices and the primary lighting device. The central portal may facilitate communication between primary lighting devices and communication devices. The central portal may be in a central location. The communication of the primary lighting fixture and communication devices can be performed using long range communication and protocols, which can be either wired or wireless, such as Wi-Fi. The communication between the primary lighting fixture, the secondary lighting fixtures and communication devices can be performed using short range communication and protocols, which can be either wired or wireless, such as Bluetooth. Communication components of the central portal may include a gateway, a router, and/or other communication devices. The gateway can include one or more protocol translators, impedance matching devices, rate converters, fault isolators, and signal translators, as necessary to provide system interoperability.

The central portal may include a web portal. The web portal can be managed by administrative/service/staff personnel from a central location, such as a remote office. The web portal can be installed on a computer. The computer can include at least a graphic user interface or display device, a processor (for example, central processing unit), a memory, a keyboard and/or any other input device, and/or any other component that can be implemented-on/connected with the computer. The web portal can connect wirelessly to a network via a network and a gateway. For example, the network can be for a particular floor in a building, be for all the floors of the building, or can be all the buildings in a city. In one aspect, the network can characterize a wireless mesh network, such as a high frequency (for example, 900 MHz, 2.4 GHz, or the like) secure ZIGBEE wireless mesh network. The network can wirelessly connect various lighting devices with each other and with other communication devices, such as the wireless gateway, a wireless sensor interface, an external sensor (for example, motion sensor), a wireless wall control interface, wireless locks for doors and a wireless light controller. The network can be the Internet, a local area network, a wide area network, or the like. In some aspects, the computer implementing the web portal can be remote to the network such that short-range communication such as Bluetooth or Infrared may not be possible. While wireless communication is described between the computer and the network, in some other implementations, the computer and the network can be connected using electrical wires. Further, while wireless communication is described within the wireless mesh network, in some other implementation, the lighting devices can be connected by electrical wires.

In some embodiments, the subject matter is decentralized application (DApp) compatible, allowing the system to run on a decentralized application. A decentralized application (dApp) is a digital application that runs on a decentralized network. DApps are open source, distributed software applications that use blockchain technology and cryptocurrency. They are community-managed and can operate autonomously, often through smart contracts. DApps are similar to traditional apps, but blockchain technology keeps users' data out of the hands of the organizations behind it.

The network protocols that can be used herein can include one or more of Bluetooth protocols, fiber channel network protocols, Li-Fi (short for “Light Fidelity,” a wireless communication technology that uses visible light, infrared, or ultraviolet spectrum to transmit data), Internet protocol suite, transmission control protocol (TCP), open systems interconnection (OSI) protocols, routing protocols, a chatting messenger protocol, real time publish subscribe (RTPS) protocol, secure shell (SSH) protocol, file transfer protocol (FTP), simple mail transfer protocol (SMTP), telephone network (Telnet), hypertext transfer protocol (HTTP), secure hypertext transfer protocol (HTTPS), secure file transfer protocol (SFTP), and secure socket layer (SSL).

The communication device 1260 may be a mobile device such as, for example, a smartphone, a tablet computer, a wearable apparatus, and/or the like. However, it should be appreciated that the communication devices 1260 may be any processor-based device including, for example, a desktop computer, a laptop or mobile computer, a workstation, and/or the like. For example, via the communication device 1260, the user may be able to access a floorplan of a building/structure for mapping lights to locations on the floorplan or scheduling. In another example, via the communication device 1260, the user may be able to program scheduling, daylight harvesting or daylighting, task tuning to optimize the level and the area of lighting, demand response (e.g., reducing peak energy demand at key times) and manual controlling of the primary lighting fixture and the secondary lighting fixture.

In some embodiments, the communication device 1260 may be a tablet or an offsite system, with the floorplan of a building/structure, for mapping lights to locations on the floorplan. The communication device 1260 may include a light to be assigned to a location that can be done with a laser pointer or a blinking pattern on the light that the camera of the tablet or offsite system could decode, or having a light turn a particular color that the user can indicate where that light is located on the floorplan. After installation, the lights could also use WiFi-LiFi to configure their proximity to each other

The display 1270 may be separately coupled as part of the communication device 1260. The display 1270 may also include a user interface. The user interface may form a part of a display 1270 screen of the display 1270 that presents information to the user (e.g., a programmer, a controller, a building maintenance worker) and/or the user interface may be separate from the display 1270. For example, the user interface may be one or more buttons, or portions of the display 1270 that is configured to receive an entry from the user.

The subject matter is backward compatible (also known as downward compatible or backward compatibility) refers to a hardware or software system that can successfully use interfaces and data from earlier versions of the system or with other systems.

The primary lighting fixture 1210, secondary lighting fixture 1230, and the communication device 1260 may have a networked together in a mesh network connection. The lighting and communication devices 1260 can be implemented in a primary-secondary configuration. For example, a primary lighting fixture can be primary lighting devices and a secondary lighting fixture can be secondary lighting devices and communication device can be a communication device. The primary lighting devices, or communication device can be strategically located above an entrance door of the conference room or above the doorway leading to the entrance door. The secondary lighting devices or communication device can be strategically located at multiple places in the conference room.

The primary lighting fixture 1210, a secondary light fixture 1220, or a communication device 1260 may have different functionalities. In a primary light fixture, the processor may direct commands and instructions to secondary light fixtures or a communication device 1260. The primary light fixtures and the secondary light fixtures can be arranged in a hierarchy, where each secondary light fixture is connected to a primary light fixture, and not a secondary light fixture. Processors in primary light fixtures or a communication device 1260 may be configured to connect to a cellular/WiFi network. Processors in primary lighting fixtures 1210 or a communication device 1260 may be connected to a secondary lighting fixture 1220 but not connected to another primary light fixture. Communication between the processors of the primary light fixtures can travel through the cellular/WiFi network. Communication between the processors of the primary light fixtures or a communication device 1260 and the secondary light fixtures can travel using a Bluetooth or other mesh network protocol.

When a primary-secondary configuration is formed in the network, the primary lighting fixture or a communication device 1260 controls or sends instructions to processors of secondary lighting fixtures. For example, when the processor of the primary lighting fixture or a communication device 1260 sends a signal to a secondary lighting fixture, the secondary lighting fixture may change color in response to a command forwarded by the processor the primary lighting fixture or a communication device 1260. In another example, the secondary lighting fixture may communicate with another device such as the photosensitive window. In such a case, the processor of the primary lighting fixture or a communication device sends an instruction to the photosensitive window to open or close the photosensitive window. Other examples of action can be either activation or deactivation of one or more heating ventilation and air conditioning (HVAC) systems, electro-sensitive windows, alarms, and the like.

In some implementations, each secondary lighting fixture can optionally have a single lighting segment (instead of a LED segment and a separate fluorescent lighting segment), and can have a receiver (for example, a short-range receiver) to receive commands from the primary lighting devices or a communication device. The primary lighting fixture can have a lower-level lighting segment (for example, LED segment) and a higher level lighting segment (for example, fluorescent lighting segment), an occupancy sensor or motion detector, and/or a transmitter (for example, a short-range transmitter). The lighting source (for example, LED lighting source) associated with the lower-level lighting segment can, in one embodiment, remain active at all times. The motion sensor described above can be used, or alternatively and/or additionally, an occupancy sensor, can be associated with the primary lighting device which can sense motion or occupancy in the room, wherein the occupancy can be a number of individuals and/or entities (for example, furniture, electronic equipment, and/or the other entities) in the room. When motion is detected or the occupancy becomes equal to or more than a predetermined threshold, the lighting source (for example, the fluorescent lighting source) associated with the higher lighting segment can be activated, and instantaneously and concurrently, one or more commands/signals can be sent to the secondary lighting fixture so as to become activated.

The lighting device mesh network 1200 may work as an alarm system. For example, “Code Blue” used in hospitals to announce that there is an emergency. The lighting device mesh network 1200 can flash the lights in the ceiling blue and then direct users in the room that there is a problem. The primary lighting fixture 1210 or a communication device 1260 may direct the secondary lighting fixtures to flash to indicate where the users should go. This could save seconds in an emergency.

In another example, if there is a fire in a building, the lights will turn orange and show you the way out of the building. The lighting device mesh network 1200 flashes the primary lighting fixtures and the secondary lighting fixtures in the ceiling orange and then direct everyone to the nearest building exit. The primary lighting fixtures may direct the secondary lighting fixtures to flash to indicate where the users should go.

The one or more commands/signals from the primary lighting fixture or a communication device 1260 to one or more secondary lighting fixture can be sent either over a wire or wirelessly. The wireless transmission can be via a communication network, such as at least one of a local area network (LAN), a wide area network (WAN), internet, Wi-Fi, Bluetooth network, infrared network, and any other network.

In one example of the networking arrangement, the fixture that can incorporate the primary lighting devices can hold/incorporate four lighting devices. For example, eight fixtures that incorporate the secondary lighting devices can hold/incorporate four lighting devices, which can be either lighting devices or lighting devices with a single segment. In one implementation, these thirty-six (that is, product of nine and four) lighting devices can be controlled by a zone lighting control. With the zone lighting control, all (or most of) the thirty-six lighting devices can be activated, deactivated, dimmed, or brightened at a same time, thereby saving energy.

In some implementations, the control of the primary lighting fixture and the secondary lighting fixture can be provided from the central location, such as the web portal that can be used by facility/service/administrative personnel. The lighting devices within the primary fixture can include communication components that facilitate communication between the primary lighting devices and the secondary lighting devices or a communication device 1260. Such communication components can include a gateway, a router, and/or other communication devices. The gateway can include one or more of protocol translators, impedance matching devices, rate converters, fault isolators, and signal translators, as necessary to provide system interoperability. One lighting device from the primary lighting devices can have an address identifying location, host, and/or location interface, such as an internet protocol (IP) address. This internet protocol address can allow an isolation/separation of this one lighting device from other, for example, thirty-five (36−1 =35) lighting devices. Here, the other thirty-five lighting devices can act as a secondary to the one lighting device, wherein the secondary can receive commands from the primary lighting fixture 1210 or a communication device 1260 for activation, inactivation, dimming, brightening, changing color, and/or the like. These thirty-five secondary lighting devices can receive wireless communication commands from the one primary lighting fixture 1210 or a communication device, thereby establishing a zone lighting environment without needing modifications to already existing fixtures.

The communication between the central location, such as the web portal, and the primary lighting device or a communication device 1260 can be performed using long-range communication and protocols, which can be either wired or wireless, such as Wi-Fi. The communication between the primary lighting device or a communication device and the secondary lighting devices can be performed using short-range communication and protocols, which can be either wired or wireless, such as Bluetooth.

Various implementations of the subject matter described herein may be realized in digital electronic circuitry, integrated circuitry, specially designed ASICs (application specific integrated circuits), computer hardware, firm-ware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The subject matter described can comprise computer executable instructions permanently stored on computer readable media, which, when executed by a computer, causes the computer to perform operations herein. Similarly, computer systems may include a processor and a memory coupled to the processor. The memory may temporarily or permanently store one or more programs that cause the processor to perform one or more of the operations described.

These computer programs (also known as programs, software, software applications or code) include machine instructions for a programmable processor and may be implemented in a high-level procedural and/or object-oriented programming language, and/or in assembly/machine language. As can be used herein, the term “machine readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (LAN), a wide area network (WAN), and the Internet.

The subject matter described can optimize usage of energy while providing full safety in structures, such as parking structures, stairwells, buildings, shelters, and the like. Further, the subject matter described can fit into previously existing fixtures, and can use previously implemented ballasts, thereby advantageously providing adaptability with existing fixtures.

The implementations set forth in the foregoing description do not represent all implementations consistent with the subject matter described herein; instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the claims.

By integrating these components effectively, the subject matter enables a wide range of applications across industries, from smart homes and cities to industrial automation and healthcare.

What is claimed is:

1. An apparatus comprising:
an LED strip having a plurality of light emitting diodes;
a tubular enclosure is configured to sustain the LED strip;
a control board having a processor, a modem, and an antenna, the processor being communicatively coupled to the LED strip having the plurality of light emitting diodes, and the processor being configured to control the light emitting diodes, the control board configured to connect to at least one of a cellular network or WiFi via the modem and the antenna;
a power board coupled to the LED strip having the plurality of light emitting diodes; and
two opposing end caps situated at both ends of the tubular enclosure configured to receive power, the two opposing end caps configured to receive power for supplying power to the power board and the control board.

2. The apparatus of claim 1, wherein the modem and the antenna receives information from the at least one of the cellular network or WiFi network, the information including a color to be generated by the plurality of light emitting diodes.

3. The apparatus of claim 1, wherein the power board is enclosed in a first end cap at a first end of the tubular enclosure, and wherein the control board is enclosed in a second end cap at a second end of the tubular enclosure, the first end opposing the second end.

4. The apparatus of claim 1, wherein the two opposing end caps have a set of pins configured to receive power from an electrical ballast via a tube socket.

5. The apparatus of claim 4, wherein the tube socket is configured to receive at least one of a T5, T8, or T12 fluorescent light.

6. The apparatus of claim 1, wherein the power board includes a transformer configured to convert power from a 120-volt alternating current source.

7. The apparatus of claim 1, wherein the power board further includes a transformer configured convert power from a ballast.

8. The apparatus of claim 1, wherein the modem is a WiFi-LiFi network and the cellular network.

9. The apparatus of claim 1, wherein the control board includes a microphone, sensor, and a speaker.

10. The apparatus of claim 1, further comprising:
a smoke sensor configured to detect polluted air, the smoke sensor being communicatively coupled to the control board,
wherein the control board is configured to generate a different color at the plurality of light emitting diodes in response to the smoke sensor detecting polluted air satisfying a polluted air threshold,
a concussion sensor configured to detect a gunshot, the concussion sensor being communicatively coupled to the control board, and
wherein the control board is configured to generate a different color at the plurality of light emitting diodes in response to the concussion sensor detecting a gunshot.

11. A system comprising:
a primary lighting device including:
a first LED strip having a first plurality of LEDs;
a first tubular enclosure is configured to sustain the first LED strip;
a first control board having a first processor, a first modem, and a first antenna, the first processor being communicatively coupled to the first LED strip having the first plurality of LEDs, and the first processor being configured to control the first plurality of LEDs, the first control board configured to connect to at least one of a cellular network or a WiFi network via the first modem and the first antenna;
a first power board coupled to the first LED strip having the first plurality of LEDs; and
two opposing end caps situated at both ends of the first tubular enclosure configured to receive power, the two opposing end caps configured to receive power for supplying power to the first power board and the first control board;
a central portal configured to wirelessly connect to the primary lighting device via at least one of the cellular network or the WiFi network, the primary lighting device being configured to receive instructions through the central portal via the at least of the cellular network or the WiFi network;
a secondary lighting device including:
a second LED strip having a second plurality of LEDs;
a second tubular enclosure is configured to sustain the second LED strip;
a second control board having a second processor, a second modem, and a second antenna, the second processor being communicatively coupled to the second LED strip having the second plurality of LEDs, and the second processor being configured to control the second plurality of LEDs, the second control board configured to connect to the primary lighting device via the second modem and the second antenna;
a second power board coupled to the second LED strip having the second plurality of LEDs; and
two opposing end caps situated at both ends of the second tubular enclosure, the two opposing end caps configured to receive power for supplying power to the second power board and the second control board;
wherein the secondary lighting device is configured to communicate with the primary lighting device via the second modem and the second antenna, and wherein the primary lighting device is configured to activate the second plurality of LEDs based on a command received by the second modem from the primary lighting device.

12. The system of claim 11, wherein the central portal is configured to generate a visual mapping of a physical layout of the primary lighting device and the secondary lighting device.

13. The system of claim 11, wherein the first modem and the second modem have separate IP addresses.

14. The system of claim 11, wherein the first modem and the second modem include at least a Bluetooth protocol.

15. The system of claim 11, wherein the first modem and the second modem are compatible with a WiFi-LiFi network and the cellular network.

16. The system of claim 11, wherein the central portal includes a gateway to a user device, wherein the command is received from a communication device.

17. The system of claim 11, wherein the two opposing end caps have a set of pins configured to receive power from an electrical ballast via a tube socket.

18. The system of claim 17, wherein the tube socket is configured to receive at least one of a T5, T8, or T12 fluorescent light.

19. The system of claim 11, wherein the first power board includes a first transformer configured to convert power from a 120-volt alternating current source or is configured to convert power from an alternating current source, and wherein the second power board includes a second transformer configured to convert power from the 120-volt alternating current source or is configured to convert power from an alternating current source.

20. The system of claim 11, wherein the first power board further includes a first transformer configured convert power from a first ballast or is configured to convert power from an alternating current source and wherein the second power board further includes a second transformer configured convert power from a second ballast or is configured to convert power from an alternating current source.
